(19) United States
(12) Patent Application Publication
(10) Pub. No.: US 2019/0300040 A1
(43) Pub. Date: Oct. 3, 2019

(54) STEERING MEMBER AND METHOD OF MANUFACTURING THE SAME

(71) Applicant: CALSONIC KANSEI CORPORATION, Saitama-shi, Saitama (JP)

(72) Inventor: Masato ABE, Saitama-shi, Saitama (JP)

(21) Appl. No.: 15/998,917

(22) PCT Filed: Feb. 6, 2017
(86) PCT No.: PCT/JP2017/004245

§ 371 Date: Jun. 17, 2019

(30) Foreign Application Priority Data
Feb. 17, 2016 (JP) 2016-028332

(51) Int. Cl. B62D 1/16; B21D 53/88

(52) U.S. Cl. CPC B62D 1/16; B62D 25/14; B21D 53/88

(57) ABSTRACT

To reliably form an effectively functioning burring hole in a steering member. The steering member includes a metal tubular main body extending in a vehicle width direction, wherein a burring hole is formed in a circumference surface of the main body, an edge of the burring hole extrudes inward the main body, and the edge of the burring hole has a droop amount in a circumference direction of the main body and a droop amount in an axis direction of the main body.

### CROSS-REFERENCE TO RELATED APPLICATION

Related applications are listed in an Application Data Sheet (ADS) filed with this application. All applications listed in the ADS are hereby incorporated by reference herein in their entireties.

### TECHNICAL FIELD

The present disclosure relates to a steering member and a method of manufacturing the same.

### BACKGROUND ART

An instrument panel is installed in a front portion of an interior of a vehicle such as an automobile. A metal steering member connecting left and right vehicle body panels is attached inside the instrument panel.

The steering member includes at least a metal main body extending in a vehicle width direction. A burring hole is formed in a circumference surface of the main body (see JP 2015-199446A, for example). An edge of the burring hole extrudes inward the main body.

A component (for example, electronic control unit) is directly attached to the main body with the burring hole formed in the main body. The burring hole eliminates the need for fixing, to the main body, a bracket which attaches the component to the main body (by welding). Accordingly, the costs and the weight of the steering member are reduced.

### SUMMARY

In the steering member described in Patent Literature 1, the extruded edge, which forms a screw engagement portion, of the burring hole has a tapered shape. The tapered screw engagement portion may disturb insertion of a screw, and reduce a screw engagement allowance. Accordingly, such a burring hole may not be appropriately used as a burring hole.

An object of this disclosure is to solve the above problem.

To achieve the above object, a steering member of the present disclosure includes a metal tubular main body extending in a vehicle width direction, wherein a burring hole is formed in a circumference surface of the main body, an edge of the burring hole extrudes inward the main body, and the edge of the burring hole has a droop amount in a circumference direction of the main body smaller than a droop amount in an axis direction of the main body.

### BRIEF DESCRIPTION OF DRAWINGS

FIG. 1 is a perspective view of a steering member according to an embodiment.

FIG. 2 is a longitudinal sectional view of an extruded edge of a burring hole of the steering member in FIG. 1.

FIG. 3 is an enlarged sectional view of the burring hole in FIG. 1 as seen from an inside of a main body.

FIG. 3A is a sectional view along a line A-A in FIG. 3.

FIG. 3B is a sectional view along a line B-B in FIG. 3.

FIG. 4 is a perspective view of a core for forming the burring hole.

FIG. 5 is a partially enlarged longitudinal sectional view of the steering member when the burring hole is formed.

FIG. 6 is a perspective view of a core according to a modified example.

FIG. 7 is a view illustrating a component attached to the main body with the burring hole.

FIG. 8 is an enlarged sectional view of the burring hole in FIG. 7.

FIG. 9 is a partially enlarged sectional view of a flat metal plate in which a burring hole is formed.

FIG. 10 is a partially enlarged sectional view of the tubularly rounded metal plate in FIG. 9.

FIG. 11 is a view illustrating a component attached to the main body with the burring hole, the main body having no flat portion.

FIG. 12 is an enlarged sectional view of the burring hole in FIG. 11.

FIG. 13 is a view illustrating the component in FIG. 11 attached to the main body with the burring hole, the component having an arc attachment portion.

FIG. 14 is a graph showing a relationship of a torque (vertical axis) and a time (horizontal axis) with respect to the attachment in FIG. 7.

FIG. 15 is a graph showing a relationship of a torque (vertical axis) and a time (horizontal axis) with respect to the attachment in FIG. 11.

FIG. 16 is a partially enlarged sectional view of the burring hole similar to FIG. 8, the view illustrating the main body having a flat portion according to a modified example.

### DESCRIPTION OF EMBODIMENTS

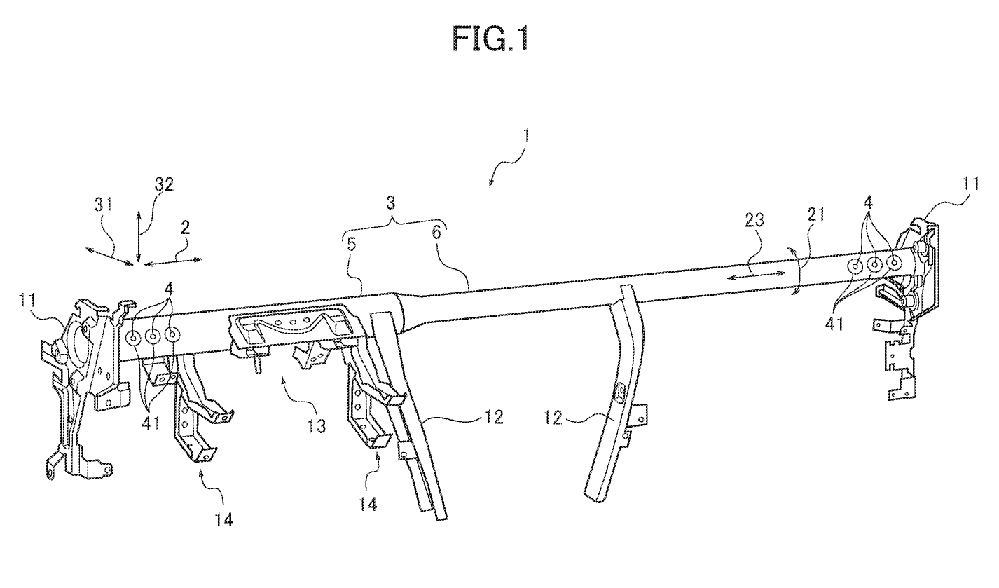

Hereinafter, an embodiment is described with reference to FIGS. 1 to 16.

### First Embodiment

Hereinafter, a configuration of this embodiment will be described.

An instrument panel is installed in a front portion of an interior of a vehicle such as an automobile. A metal steering member 1 connecting left and right vehicle body panels is attached inside the instrument panel, as illustrated in FIG. 1.

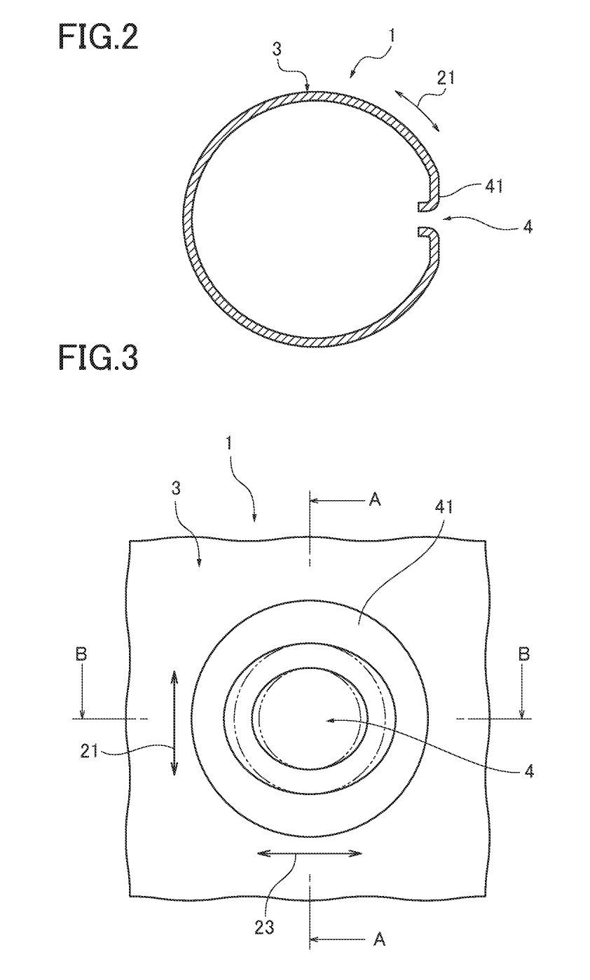

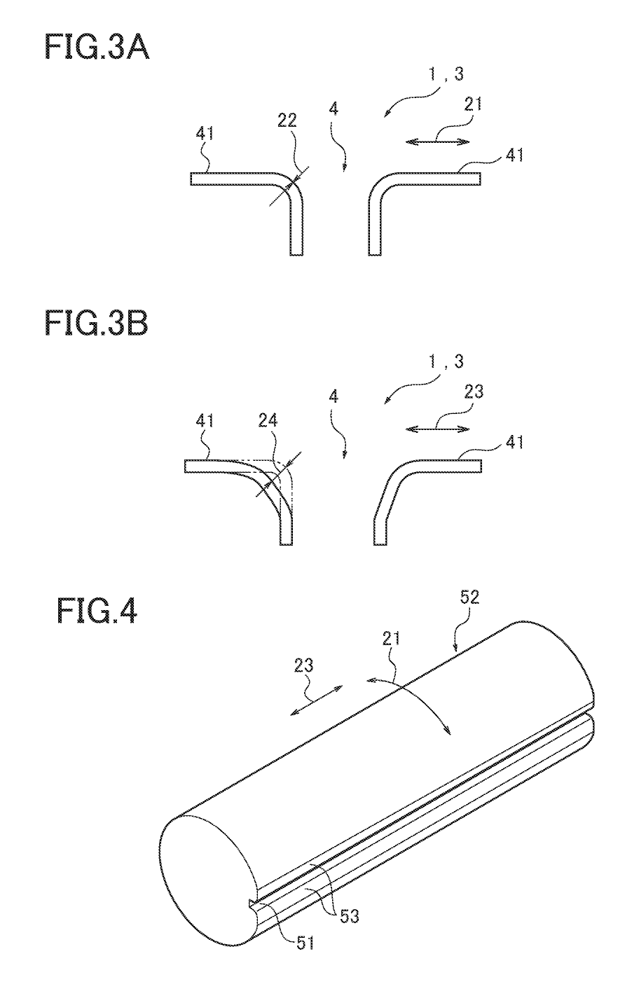

The steering member 1 includes at least a tubular main body 3 extending in a vehicle width direction 2. As illustrated in FIGS. 2, 3, a burring hole 4 is formed in a circumference surface of the main body 3. An edge of the burring hole 4 extrudes inward the main body 3.

As illustrated in FIG. 1, the main body 3 has a cylinder shape or a square tube shape. In this embodiment, the main body 3 is a cylinder main body having a uniform thickness. The main body 3 may have the same diameter over the entire length. The main body 3 may have a large diameter (large diameter portion 5) on a driver's seat side and a small diameter (small diameter portion 6) on a front passenger's seat side according to differences in required strength.

For example, various brackets (attachment brackets) are integrally attached to the main body 3 by welding. The various brackets include a side bracket 11, a stay 12, a column bracket 13, and a knee protector 14. The side bracket 11 is used to attach the main body 3 to the vehicle body panel. The stay 12 supports the main body 3 on a floor panel. The column bracket 13 is used to attach a steering column. The knee protector 14 protects a knee of a passenger.

As illustrated in FIGS. 2, 3, the extruded edge of the burring hole 4 has an approximate cylinder shape. The burring hole 4 is formed by a punching process with a press and an extruding process (burring process). Preferably, the edge of the burring hole 4 extrudes in a radius direction toward the center of the main body 3.

This embodiment includes the following configurations in addition to the above basic configurations.

Hereinafter, the steering member 1 is described.

(1) As illustrated in FIGS. 3A, 3B, the edge of the burring hole 4 has a droop amount 22 in a circumference direction 21 of the main body 3 smaller than a droop amount 24 in an axis direction 23 of the main body 3 (droop amount 22 in circumference direction 21≤droop amount 24 in axis direction 23).

The droop amount 22, 24 is deformation of the edge of the burring hole 4 punched and extruded in the burring process. More specifically, the droop amount 22, 24 is deformation of a base portion of the extruded edge of the burring hole 4, which is plastically deformed to a tapered shape or an arc shape, when a punch (after-described punching tool 55) is pushed onto a processing surface of the main body 3. The main body 3 is disposed such that the axis direction 23 is substantially aligned with the vehicle width direction 2. Note that the droop amount 22, 24 is exaggeratedly drawn in the figures.

(2) As illustrated in FIG. 1, a plurality of burring holes 4 is linearly arranged along the axis direction 23 of the main body 3.

In this embodiment, three burring holes 4 are linearly arranged near the end portion of the small diameter portion whereas three burring holes 4 are linearly arranged near the end portion of the large diameter portion. However, the number and the positions of the burring holes 4 are not limited to the above.

(3) The burring hole 4 is formed in the main body 3 to face a rear side of a vehicle.

The rear side of the vehicle means a rear portion of the vehicle in a vehicle longitudinal direction 31. The burring hole 4 is formed such that its axis is substantially aligned with the horizontal direction with respect to a vertical direction 32. However, the axis of the burring hole 4 is not always necessary to be aligned with the horizontal direction. The burring hole 4 may be formed to face other portions of the vehicle in addition to the rear portion of the vehicle.

(4) As illustrated in FIG. 2, a flat portion 41 is provided around the burring hole 4.

The flat portion 41 has a uniform thickness which is the same thickness as the main body 3. The flat portion 41 is provided at least partly around each of the burring holes 4 of the main body 3. A plurality of flat portions 41 may be overlapped each other or may not be overlapped each other.

Hereinafter, a method of manufacturing the steering member 1 is described.

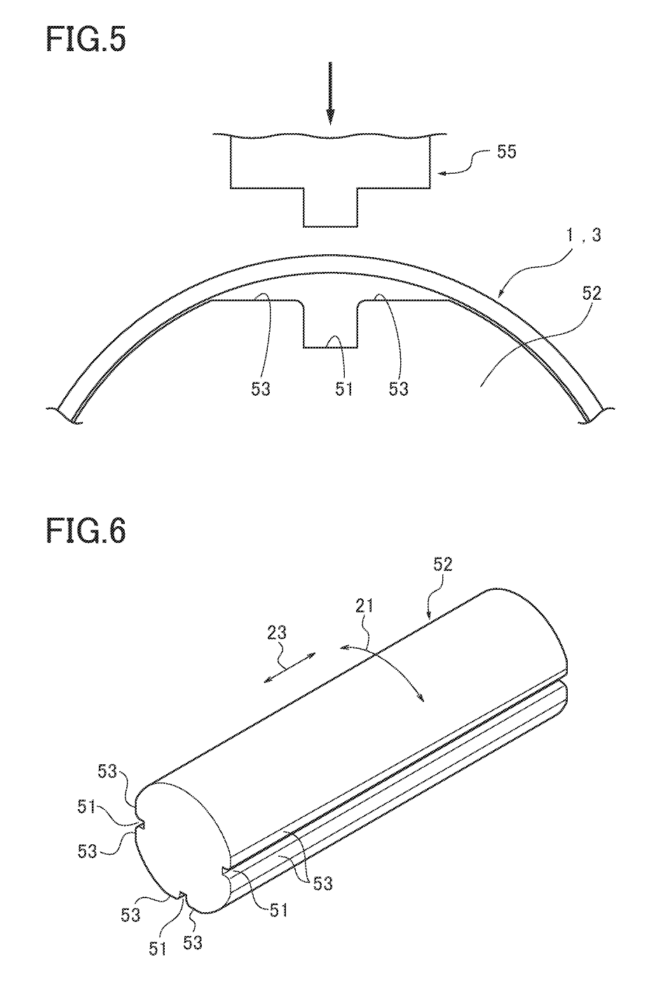

(5) The method of manufacturing the steering member 1 includes a step of forming the burring hole 4 in the circumference surface of the metal tubular main body 3 extending in the vehicle width direction 2. The edge of the burring hole 4 extrudes inward the main body 3. In this step, as illustrated in FIG. 4, a columnar core 52 having a groove 51 extending in the axis direction 23 is inserted into the tubular main body 3. As illustrated in FIG. 5, the burring hole 4 is formed in the main body 3 by the burring process such that the edge of the burring hole 4 has the droop amount 22 in the circumference direction 21 of the main body 3 smaller than the droop amount 24 in the axis direction 23 of the main body 3. The burring process is performed to the main body 3 from the outside thereof in accordance with the position of the groove 51.

The axis direction 23 is aligned with the axis direction 23 of the core 52. When the core 52 is inserted into the main body 3, the axis direction 23 of the core 52 is aligned with the axis direction 23 of the main body 3. Similarly, when the core 52 is inserted into the main body 3, the circumference direction 21 of the core 52 is aligned with the circumference direction 21 of the main body 3.

The groove 51 is a square groove having a width equal to the diameter of the burring hole 4 and a depth equal to the extrusion amount of the edge of the burring hole 4. The columnar core 52 has the same sectional shape (columnar shape) as the main body 3. The diameter of the core 52 is substantially the same as the inner diameter of the main body 3. When the burring hole 4 is provided in the large diameter portion 5 and the small diameter portion 6, the core 52 in a size suitable for each portion is used. A flat surface 53 for forming the flat portion 41 is provided around the groove 51 of the core 52. The burring hole 4 and the flat portion 41 are simultaneously formed in the tubular main body 3 by a convex punching tool 55, as illustrated in FIG. 5.

(6) As illustrated in FIG. 6, a plurality of burring holes 4 differently located along the circumference direction 21 may be formed by the core 52 having a plurality of grooves 51 differently located along the circumference direction 21. Each of the grooves 51 extends in the axis direction 23.

In this case, a plurality of grooves 51 is formed in the core 52 at sufficient intervals in the circumference direction 21. In this embodiment, a plurality of grooves 51 is formed at 90 degree intervals. The flat surface 53 is provided around each groove 51. The burring holes 4 are thereby formed in the main body 3 by a plurality of grooves 51 to face the rear side, the front side, and the lower side of the vehicle.

Hereinafter, the operations of the embodiment are described.

The steering member 1 is provided inside the instrument panel to connect the left and right vehicle body panels body 3. Thus, the thickness and the weight of the main body 3 are easily reduced while maintaining the rigidity of the main body 3.

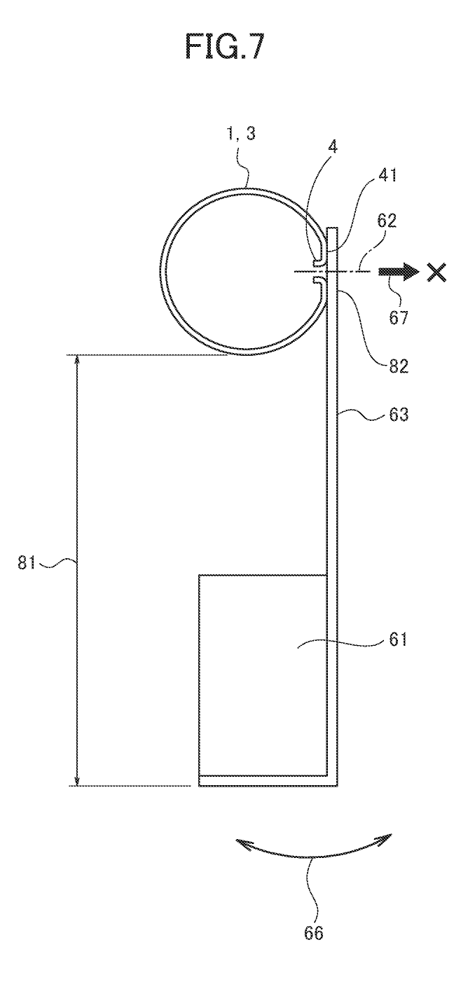

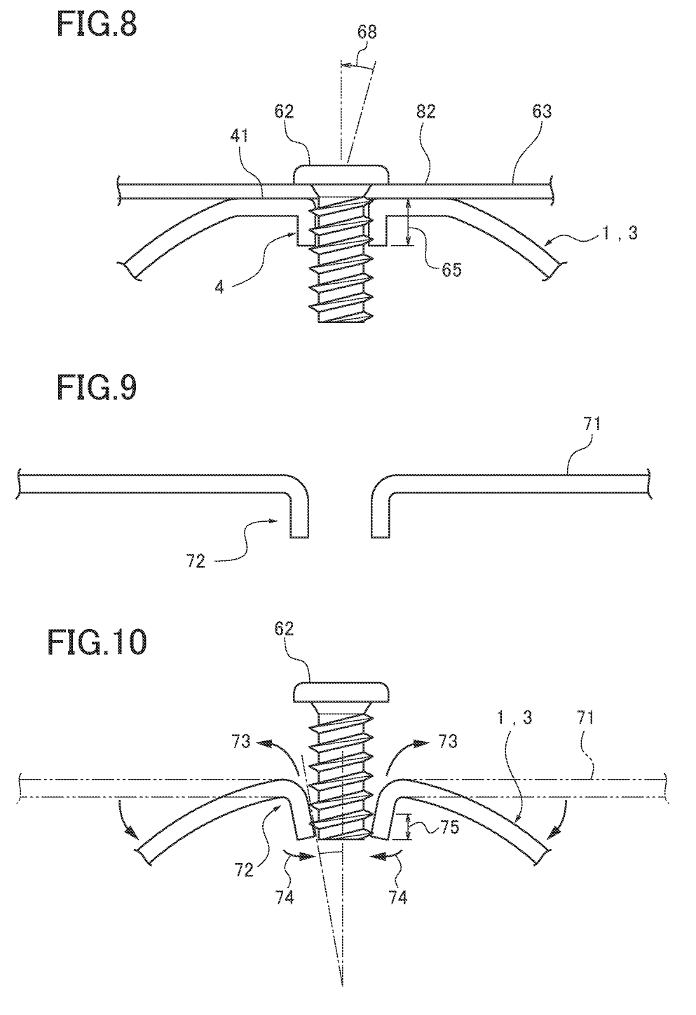

The burring hole 4 is formed in such a tubular main body 3. As illustrated in FIGS. 7, 8, a component 61 (for example, electronic control unit) can be directly attached to the burring hole 4 of the main body 3 with a screw 62 without using a bracket which is fixed to the main body 3 by welding, for example. In addition, a support bracket 63 is used for attaching the component 61. Note that as the support bracket 63 is not fixed to the main body 3, no another step such as welding is required.

Accordingly, the burring hole 4 eliminates a need for integrally fixing, to the main body 3, many brackets (attachment brackets) for attaching the component 61. The number of brackets is thereby reduced, and the step of welding such brackets is omitted. Thus, the weight and the costs of the main body 3 can be reduced.

The extruded edge of the burring hole 4 has a screw engagement allowance 65 (refer to FIG. 8) larger than that of a standard hole (or a fastened portion by the screw 62 in an axis direction longer than that of a standard hole). The increased screw engagement allowance 65 therefore further reliably holds the component 61. Accordingly, as illustrated in FIG. 7, falling 67 of the component 61 due to vibration 66 of the main body 3 and the component 61 can be effectively prevented. The increased screw engagement allowance 65 also offers a function of guiding the screw 62 into the burring hole 4 at a right insertion angle regardless of a difference 68 (refer to FIG. 8) in the insertion angle of the screw 62.

In some cases, the burring hole 4 of the main body 3 is formed as follows. After a burring hole 72 is formed in a flat metal plate 71 in a burring process (stamping process), as illustrated in FIG. 9, the flat metal plate 71 is rounded to form the tubular main body 3, as illustrated in FIG. 10.

However, when the flat metal plate 71 is rounded, a force 73 which stretches the metal plate 71 in the circumference direction 21 acts on the base portion of the extruded edge of the burring hole 72, and a force 74 which compresses the metal plate 71 in the circumference direction 21 acts on a tip portion of the extruded edge of the burring hole 72. These forces 73, 74 make the fastened portion of the extruded edge of the burring hole 72 tapered. The tapered fastened portion of the extruded edge of the burring hole 72 may disturb the insertion of the screw 62 and may reduce an effectively functioning screw engagement allowance 75. Thus, such a burring hole 72 may not be effectively used.

The following effects are obtained by this embodiment.

### Effect 1

The burring hole 4 of the main body 3 is formed such that the extruded edge of the burring hole 4 has the droop amount 22 in the circumference direction 21 of the main body 3 smaller than the droop amount 24 in the axis direction 23 of the main body 3. All of the extruded edges of the burring holes 4 formed in the tubular main body 3 by the after process have the small droop amount 22 in the circumference direction 21 of the main body 3. The extruded edge of the burring hole 4 having the small droop amount 22 in the circumference direction 21 constitutes the effective screw engagement allowance 65 over the entire region in the screw axis direction. The burring hole 4 is therefore effectively used, the screw 62 is reliably inserted into the burring hole 4, and the engagement performance can be improved.

The burring hole 4 was compared to an ideal burring hole 4. As a result, the fastening force of the extruded edge of the burring hole 4 was slightly lower than the fastening force of the extruded edge the ideal burring hole 4. However, a difference between the fastening forces of the extruded edges of these holes was small value within about 10%. For example, the small component 61 of about 2 kg was found safely held by the main body 3 even when the component 61 was disposed at a distance 81 (refer to FIG. 7) about 400 mm from the main body 3.

### Effect 2

A plurality of burring holes 4 is formed in the main body 3 along the axis direction 23. A plurality of components 61 can be thereby directly attached to the main body 3 with the burring holes 4.

A plurality of burring holes 4 is linearly arranged. A plurality of components 61 can be thereby regularly attached to the main body 3 along the axis direction 23.

### Effect 3

The burring hole 4 is formed in the main body 3 to face the rear side of the vehicle. A worker standing in the rear side of the vehicle to face the main body 3 can easily attach the component 61 to the main body 3. The operation performance can be therefore improved. The components 61 around the main body 3 can be laid out to be aligned in the vehicle longitudinal direction 31.

### Effect 4

The flat portion 41 is provided around the burring hole 4. As illustrated in FIGS. 7, 8, an attachment portion 82 of the component 61 (or support bracket 63) thereby contacts the flat portion 41 with a wide contact area. Thus, the component 61 can be stably attached to the burring hole 4. In this case, the attachment portion 82 of the component 61, which has a flat surface capable of contacting the flat portion 41 with a surface, is applicable to plural types of main bodies 3 each having a different diameter. The attachment portion 82 is therefore applicable (widely useable) to many members.

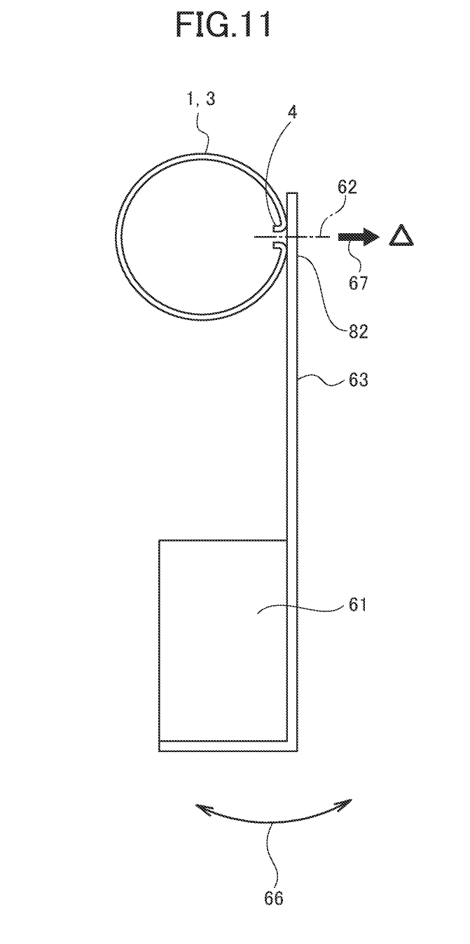

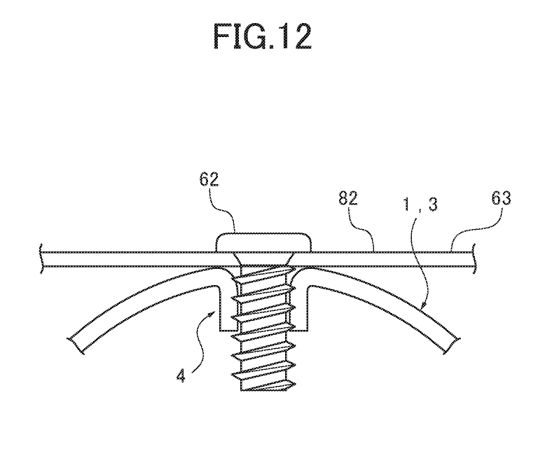

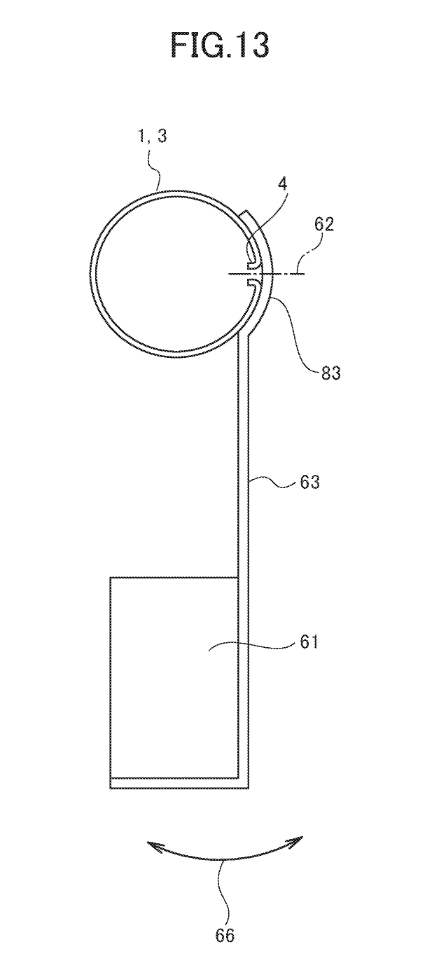

On the other hand, when the flat portion 41 is not provided around the burring hole 4, as illustrated in FIGS. 11, 12, the cylinder surface of the main body 3 contacts the flat attachment portion 82 of the component 61 with a line. This line contact lowers the friction force between the main body 3 and the component 61, and makes difficult to stably attach the component 61 to the main body 3, compared to the main body 3 in which the flat portion 41 is provided around the burring hole 4. Additionally, as illustrated in FIG. 13, an attachment portion 83 of the support bracket 63 may be formed into an arc shape having a diameter of the main body 3 to expand a contact area. The attachment portion 83 may stably attach the component 61 to the main body 3. However, such a configuration is not applicable to different main bodies 3 having different diameters, and cannot be widely used for different main bodies 3.

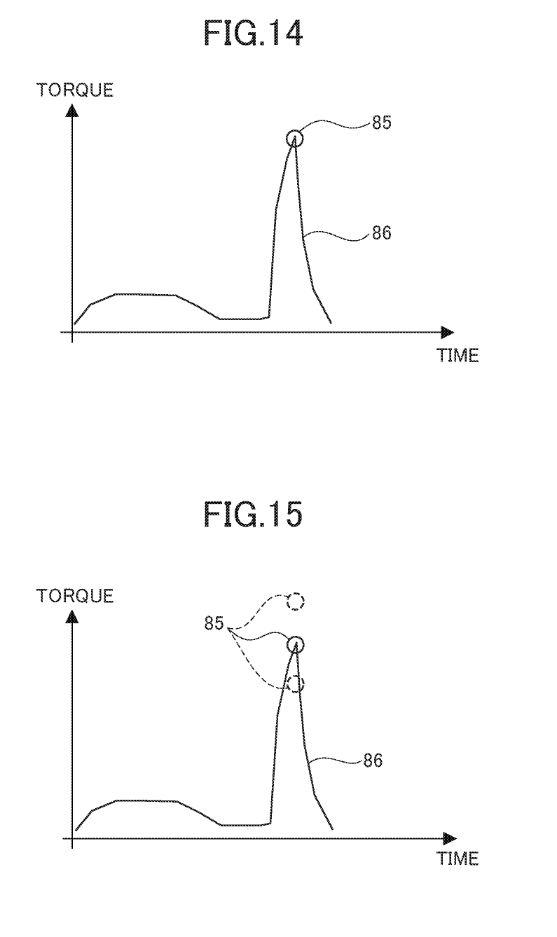

As illustrated in FIG. 8, when the support bracket 63 and the main body 3 are fastened by the screw 62, the flat portion 41 stably contacts the flat surface (attachment portion 82 of support bracket 63) of the component 61 with a wide area. This contact with a wide area stabilizes a breakdown torque 85 of the screw 62, as shown in the graph of FIG. 14, by a large friction force generated between these portions. Accordingly, the stabilized breakdown torque 85 effectively prevents the damage of the screw 62 (or collapse of screw head or threaded hole), which is caused when the fastening force 86 to be applied to the screw 62 exceeds the breakdown torque 85.

As illustrated in FIGS. 11, 12, when the flat portion 41 is not provided around the burring hole 4, the cylinder surface of the main body 3 contacts the flat attachment surface of the component 61 with a line. This line contact lowers a friction force between these portions, and destabilizes the breakdown torque 85 of the screw 62, as shown in the graph of FIG. 15, by the differences in the contact angles of the flat attachment surface (attachment portion 82) of the component 61. For this reason, the fastening force 86 of the screw 62 may exceed the breakdown torque 85, and the screw 62 may be damaged. The configuration in which the flat portion 41 is not provided around the burring hole 4 makes difficult to control the torque of the screw 62. Such a configuration is disadvantageous compared to the configuration in which the flat portion 41 is provided around the burring hole 4.

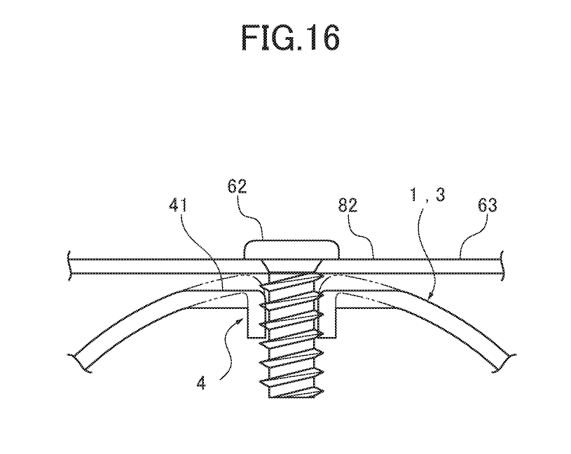

The flat portion 41 provided around the burring hole 4 makes the circumference of the burring hole 4 elastically deform to an external force as illustrated by a virtual line in FIG. 16 easier than the configuration in which the flat portion 41 is not provided around the burring hole 4. More specifically, the elastic deformation of the flat portion 41 which restores to the cylinder surface can be positively used. Such deformation around the burring hole 4 absorbs the external force, and prevents the external force from concentrating on the screw 62.

As a result, the component 61 is further reliably fastened to the burring hole 4, and the fastening force is stronger than the external force such as the vibration 66. The component 61 is therefore stably fastened to the burring hole 4 without loosening the fastening and the falling 67 of the component 61. A specific counter measurement to the vibration 66 becomes unnecessary.

On the other hand, when the flat portion 41 is not provided around the burring hole 4, the main body 3 does not elastically deform. Such a main body 3 does not absorb the external force. The external force, which easily concentrates on the screw 62, easily causes the loosening of the screw 62 and the falling 67 of the component 61 by the loosening. Accordingly, such a configuration is disadvantageous.

Moreover, the thickness of the flat portion 41, which is the same as that of the main body 3, prevents the stress from concentrating on the flat portion 41.

The method of manufacturing the steering member 1 obtains the following effects.

### Effect 5

It is difficult to form the burring hole 4 having a perfect shape in the tubular main body 3. For this reason, the columnar core 52 having the groove 51 extending in the axis direction 23 of the main body 3 is inserted into the main body 3. After that, the burring process is performed to the main body 3 from its outside in accordance with the position of the groove 51 to form the burring hole 4 in the main body 3. The extruded edge of the burring hole 4 thereby has the droop amount 22 in the circumference direction 21 of the main body 3 smaller than the droop amount 24 in the axis direction 23 of the main body 3.

This method avoids the defective shape of the screw engagement portion of the extruded edge of the burring hole 4. The defective shape of the screw engagement portion is a tapered shape which is obtained when the flat metal plate 71 is rounded to obtain the tubular main body 3 after performing the burring process to the flat metal plate 71.

All of the extruded edges of the burring holes 4 obtained in this embodiment are fully applicable. For example, the screw 62 is appropriately inserted into the burring hole 4, and the screw 62 is reliably engaged with the burring hole 4.

The columnar core 52, which is used to form the burring hole 4 in the tubular main body 3, prevents the main body 3 from being deformed. Accordingly, the burring hole 4 can be definitely processed even when the main body 3 has a lowered strength.

The burring hole 4, which is formed in accordance with the position of the groove 51 51 provided in the columnar core 52 to extend in the axis direction 23, improves its positional accuracy and the accuracy of its shape.

The shape around the burring hole 4 in the main body 3 can be thereby stabilized. The stabilized shape around the burring hole 4 improves the attachment accuracy of the component 61 to the main body 3, and prevents the interference of the components 61 and low-grade sound due to the interference of the components 61. The difference 68 in the operation for each main body 3 can be controlled.

The columnar core 52 having the groove 51 extending in the axis direction 23 can be taken out from the main body 3 after the burring hole 4 is formed.

### Effect 6

A plurality of burring holes 4 differently located along the circumference direction 21 is formed by using the core 52 having a plurality of grooves 51 differently located along the circumference direction 21. Each of the grooves 51 extends in the axis direction 23. The burring holes 4 can be thereby formed in the various positions of the main body 3 along the circumference direction 21.

1. A steering member comprising:
a metal tubular main body extending in a vehicle width direction, wherein
a burring hole is formed in a circumference surface of the main body,
an edge of the burring hole extrudes inward the main body, and
the edge of the burring hole has a droop amount in a circumference direction of the main body smaller than a droop amount in an axis direction of the main body.

2. The steering member according to claim 1, wherein a plurality of the burring holes is linearly arranged along the axis direction of the main body.

3. The steering member according to claim 1, wherein the burring hole is formed in the main body to face a rear side of a vehicle.

4. The steering member according to claim 1, wherein a flat portion is provided around the burring hole.

5. A method of manufacturing a steering member, comprising
inserting, into a metal tubular main body, a columnar core having a groove extending in an axis direction when forming a burring hole in a circumference surface of the metal tubular main body extending in a vehicle width direction, an edge of the burring hole extruding inward the main body; and
forming the edge of the burring hole to have a droop amount in a circumference direction of the main body smaller than a droop amount of the main body in the axis direction by applying a burring process to the main body from outside in accordance with a position of the groove.

6. The method according to claim 5, forming a plurality of burring holes differently located along a circumference direction by using a core having a plurality of grooves differently located along the circumference direction, each of the grooves extending in the axis direction.
